(19) United States
(12) Patent Application Publication
(10) Pub. No.: US 2022/0067165 A1
(43) Pub. Date: Mar. 3, 2022

(54) SECURITY MEASUREMENT METHOD AND SECURITY MEASUREMENT DEVICE FOR STARTUP OF SERVER SYSTEM, AND SERVER

(71) Applicants: Inventec (Pudong) Technology Corporation, Shanghai (CN); INVENTEC CORPORATION, Taipei (TW)

(72) Inventors: Wei HUANG, Shanghai (CN); Zhongying QU, Shanghai (CN)

(73) Assignees: Inventec (Pudong) Technology Corporation, Shanghai (CN); INVENTEC CORPORATION, Taipei (TW)

(21) Appl. No.: 17/137,391

(22) Filed: Dec. 30, 2020

(30) Foreign Application Priority Data
Aug. 27, 2020 (CN) 2020108793312

(51) Int. Cl. G06F 21/57; G06F 21/60; G06F 11/30

(52) U.S. Cl. CPC G06F 21/575; G06F 21/577; G06F 2221/2153; G06F 11/3096; G06F 21/602

(57) ABSTRACT

The present disclosure provides a security measurement method and security measurement device for startup of a server system, and a server. The security measurement method for startup of a server system is applied to a trusted platform control module of the server system, and the method includes: starting the trusted platform control module after the server system is powered on; measuring subsequent startup operations of the server system by the started trusted platform control module to identify and record safety of the startup operations. By adopting the trusted platform control module, the present disclosure effectively improves the safety of startup of the server system.

### CROSS REFERENCE TO RELATED APPLICATION

The present application is related to and claims the benefit of priority to Chinese Patent Application No. 2020108793312, entitled “Security Measurement Method and Security Measurement Device for Startup of Server System, and Server”, filed with CNIPA on Aug. 27, 2020, the contents of which are incorporated herein by reference in its entirety.

### BACKGROUND

### Field of Disclosure

The present disclosure relates to the technical field of server system startup, in particular, to a security measurement method and security measurement device for startup of a server system, and a server.

### Description of Related Arts

At present, most of the server models on the market as trusted computing nodes use TPM (Trusted Platform Module) or TCM (Trusted Cryptographic Module) as trusted protection components. TPM or TCM mainly provides commercial cryptographic algorithm support to achieve functions such as integrity measurement, trusted storage, and trusted report.

The traditional methods mainly have the following bottlenecks: First, the TPM standard was first proposed by foreign IT companies. At present, most of the TPM chips or modules on the market are occupied by several foreign companies. Although twelve domestic manufacturers jointly launched the TCM standard, the TCM application is still not as good as the TPM application. Second, regardless of TPM or TCM, they can only achieve trusted protection passively, and only when the application calls the TPM/TCM cryptographic algorithm can it work.

### SUMMARY

The present disclosure provides a security measurement method and security measurement device for startup of a server system, and a server, to solve the problem that TPM or TCM in the prior art can only be passively trusted, resulting in the technical problem that the security of startup of the server system is difficult to improve.

The present disclosure provides a security measurement method for startup of a server system. The method is applied to a trusted platform control module of the server system, and the method includes: starting the trusted platform control module after the server system is powered on; measuring subsequent startup operations of the server system by the started trusted platform control module to identify and record safety of the startup operations.

In an embodiment of the present disclosure, the trusted platform control module comprises a preset encryption algorithm and a preset trusted base; the measuring of the startup operation by the trusted platform control module includes: obtaining relevant information of the startup operations; performing encryption calculation on the related information by using the preset encryption algorithm, and comparing a calculation result with the preset trusted base; if a comparison result is consistent, determining the startup operation is safe; if the comparison result is inconsistent, determining the startup operation is unsafe.

In an embodiment of the present disclosure, the measuring of the subsequent startup operations of the server system by the started trusted platform control module is performed step-by-step and includes: measuring a system firmware through firmware information read by an SPI (Serial Peripheral Interface) master signal before starting the system firmware; sequentially measuring a hardware and an operating system boot file of the server system through hardware information collected by an BIOS (Basic Input Output System) after the BIOS runs; and measuring the operating system and an application program of the operating system through a background process after the operating system runs.

In an embodiment of the present disclosure, the method further includes: determining measurement results of startup operations, terminating the subsequent startup operations if a measurement result of one of the startup operations is unsafe

The present disclosure further provides a security measurement device for startup of a server system, the device is applied to a trusted platform control module of the server system, and the device includes: a startup unit, configured to start the trusted platform control module after the server system is powered on; and a measurement unit, configured to measure subsequent startup operations of the server system by the started trusted platform control module to identify and record safety of the startup operations.

In an embodiment of the present disclosure, the trusted platform control module comprises a preset encryption algorithm and a preset trusted base; the measuring of the startup operation by the trusted platform control module includes: obtaining relevant information of the startup operations; performing encryption calculation on the related information by using the preset encryption algorithm, and comparing a calculation result with the preset trusted base; if a comparison result is consistent, determining the startup operation is safe; if the comparison result is inconsistent, determining the startup operation is unsafe.

In an embodiment of the present disclosure, the measuring of the subsequent startup operations of the server system by the started trusted platform control module is performed step-by-step and includes: measuring a system firmware through firmware information read by an SPI (Serial Peripheral Interface) master signal before starting the system firmware; sequentially measuring a hardware and an operating system boot file of the server system through hardware information collected by an BIOS (Basic Input Output System) after the BIOS runs; and measuring the operating system and an application program of the operating system through a background process after the operating system runs.

In an embodiment of the present disclosure, the measurement unit is further configured to: determine measurement results of startup operations, terminate the subsequent startup operations if a measurement result of one of the startup operations is unsafe.

The present disclosure further provides a server, including: a trusted platform control module; the trusted platform control module includes the above security measurement device for startup of a server system.

In summary, the security measurement method and security measurement device for startup of a server system, and a server of the present disclosure adopt the TPCM (Trusted Platform Control Module). On the one hand, the active measurement of trusted nodes is realized; on the other hand, the security measurement of the operations of the trusted nodes is realized, a complete trusted chain is established, and a more secure startup process is realized.

### BRIEF DESCRIPTION OF THE DRAWINGS

FIG. 1 shows a schematic diagram of an installation position of a TPCM module in a server according to an embodiment of the present disclosure.

FIG. 2 shows a flowchart of a security measurement method for startup of a server system according to an embodiment of the present disclosure.

FIG. 3 shows a flowchart of a security measurement method for startup of a server system according to another embodiment of the present disclosure.

FIG. 4 shows a structural diagram of a security measurement device for startup of a server system according to an embodiment of the present disclosure.

### DETAILED DESCRIPTION OF THE PREFERRED EMBODIMENTS

The embodiments of the present disclosure will be described below through exemplary embodiments. Those skilled in the art can easily understand other advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure. It needs to be stated that the following embodiments and the features in the embodiments can be combined with one another under the situation of no conflict.

It needs to be stated that the drawings provided in the following embodiments are just used for schematically describing the basic concept of the present disclosure, thus only illustrating components only related to the present disclosure and are not drawn according to the numbers, shapes and sizes of components during actual implementation, the configuration, number and scale of each component during actual implementation thereof may be freely changed, and the component layout configuration thereof may be more complex.

In view of the fact that both TPM or TCM in the prior art can only achieve passive and trusted protection, which makes it difficult to improve the security of startup of the server system, the present disclosure proposes to adopt the state-owned standard TPCM (trusted platform control module) with domestic independent intellectual property rights for trusted protection to achieve a more secure startup process.

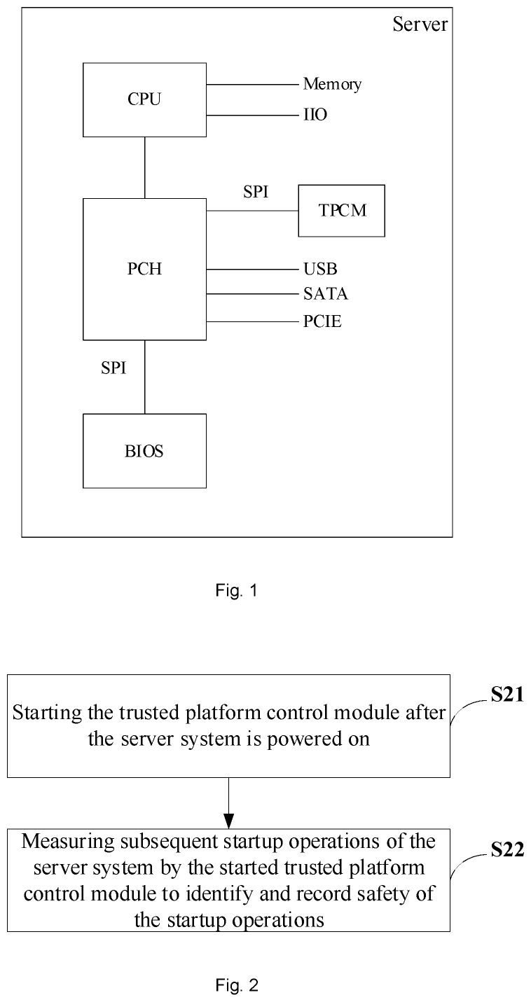

FIG. 1 shows a server architecture of this embodiment. The difference from the general server architecture is that the server of this embodiment includes a TPCM module, which is connected with the SPI interface of PCH (Platform Controller Hub).

FIG. 2 shows a security measurement method for startup of a server system in this embodiment. The method is executed by the TPCM module in FIG. 1, and includes the following operations:

S21: starting the trusted platform control module after the server system is powered on;

S22: measuring subsequent startup operations of the server system by the started trusted platform control module to identify and record safety of the startup operations.

Specifically, the trusted platform control module includes a preset encryption algorithm and a preset trusted base. The preset encryption algorithm is preferably the hash algorithm specified in the TPCM national standard. The present disclosure adopts the encryption algorithm specified in the TPCM standard instead of other encryption algorithms, because it does not damage the traditional TPCM, thereby ensuring the reliability of the TPCM, thus further ensuring the effectiveness of this method. The “trusted base” is also introduced in the TPCM national standard. The establishment of the preset trusted base in the present disclosure is based on the relevant information collected and sent to TPCM during BIOS initialization. TPCM will encrypt the result of this information as the preset trusted base, which is supposed to be constant. When the server system encounters problems such as man-made damage or hacking, the relevant information will be forcibly modified, and the result of encryption based on the modified relevant information will no longer be consistent with the preset trusted base.

The measuring of the startup operation by the trusted platform control module includes: first, obtaining relevant information of the startup operations; second, performing encryption calculation on the related information by using the preset encryption algorithm, and comparing a calculation result with the preset trusted base; if a comparison result is consistent, determining the startup operation is safe; if the comparison result is inconsistent, determining the startup operation is unsafe.

Preferably, in order to ensure the safety of the entire startup process, the measurement of TPCM should cover all operations of the startup process as much as possible, as well as hardware and software problems that may occur in each operation. Specifically, the measuring of the subsequent startup operations of the server system by the started trusted platform control module is performed step-by-step and includes: measuring a system firmware through firmware information read by an SPI master signal before starting the system firmware; sequentially measuring a hardware and an operating system boot file of the server system through hardware information collected by an BIOS (Basic Input Output System) after the BIOS runs; and measuring the operating system and an application program of the operating system through a background process after the operating system runs. In addition, TPCM determines measurement results of startup operations, terminates the subsequent startup operations if a measurement result of one of the startup operations is unsafe.

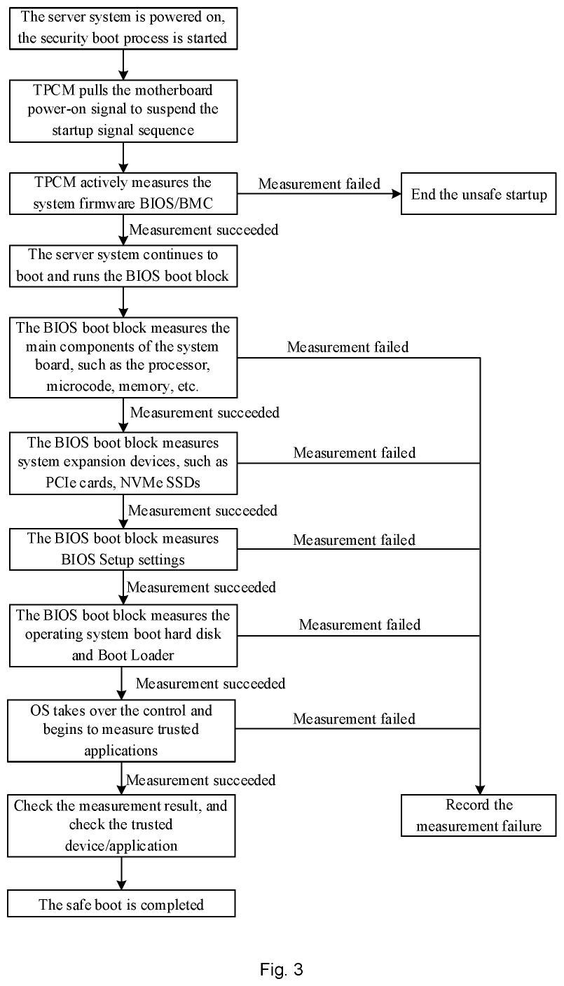

The security measurement method for startup of a server system of the present disclosure will be described in detail below with reference to FIG. 3.

After the server system is powered on, the security boot process is started. TPCM starts first (before the system firmware), pulls the motherboard power-on signal to suspend the startup signal sequence, and actively measures the system firmware BIOS/BMC (Basic Input Output System/Baseboard Management Controller). If the measurement is successful, the next step of measurement is performed. If the measurement fails, it means that the startup is unsafe. The subsequent startups can be chosen to be stopped based on the content of the preset startup strategy.

It should be noted that when TPCM measures the entire system firmware, it needs to be performed before the system firmware runs. Therefore, the TPCM module must have two aspects of design: first, the TPCM module can pull the power reset signal of the system, that is, lock the power sequence and pause DC power-on process; second, TPCM must be able to read the BIOS/BMC firmware content with the SPI master signal.

The server system continues to boot and runs the BIOS boot block. After the BIOS runs, the BIOS boot block begins to measure the main components of the system board, such as the processor, microcode, memory, etc. Subsequently, the BIOS boot block begins to measure system expansion devices, such as PCIe (Peripheral Component Interconnect express) cards, NVMe (Non-Volatile Memory express) SSDs (Solid State Drives), etc., or to measure BIOS Setup settings. It should be noted that the BIOS boot block measures the system expansion devices and Setup settings in no particular order. Then, the BIOS boot block begins to measure the operating system boot hard disk and Boot Loader. In the measurement process, if a measurement fails in a certain operation, the related information about the measurement failure is recorded, and a preset startup strategy can also be set to end the startup when the measurement result of a certain operation fails.

It should be noted that the above-mentioned BIOS boot block starts to measure, which means to collect the relevant hardware information of the corresponding operation and send it to the TPCM. As shown in FIG. 1, the information is sent by the BIOS and reaches the TPCM via the SPI interface and PCH (Paging Channel), the information is encrypted by TPCM using a preset encryption algorithm, and then the encrypted result is compared with the preset trusted base. If the comparison result is consistent, the measurement is successful; if the comparison result is inconsistent, the measurement fails.

The BIOS boot block collects hardware information of the processor CPU, including but not limited to: unique identifier ID, serial number SN, description string, and running microcode. The BIOS needs to collect the information about the CPU during the startup process and send it to the TPCM module for measurement to ensure that the CPU is not artificially replaced or damaged.

The BIOS boot block collects hardware information of memory, including but not limited to: manufacturer, memory size, frequency, serial number, production date, and memory installation configuration, and sends it to the TPCM module for measurement to ensure that the memory configuration remains unchanged.

X86 architecture servers have a large number of PCIe expansion cards. PCIe expansion cards have independent firmware drivers and need to be loaded during the BIOS POST process to complete the initialization of the expansion cards and their attached devices. When executing the firmware driver of the expansion card, the driver will have the temporary control right of the POST process. To ensure the credibility of the driver, the BIOS must measure the security of the driver before loading the driver. During POST, the BIOS grabs all the PCIe bus/device/function number, vendor ID, device ID, and FW OPROM assigned by any expansion card as the measurement information of the expansion card.

The BIOS can enable or disable the devices or functions installed or expanded on the system according to the Setup settings. Many applications under the OS (Operating System) will completely depend on the correctness of the Setup setting values. To ensure that the Setup settings meet the needs of users, the BIOS needs to send all or user-customized option settings to the TPCM module for measurement during the POST process to ensure that the system functions normally after startup.

After the main hardware measurement of the server system is completed, the BIOS sends instructions to the OS to call the operating system add-ons, so that the OS begins to take over the control and begins to measure trusted applications. At this time, the OS collects relevant software information and sends it to TPCM. The TPCM encrypts the information using a preset encryption algorithm. Then the encryption result is compared with the preset trust base. If the comparison result is consistent, the measurement is successful; if the comparison result is inconsistent, the measurement fails, and information about the measurement failure is recorded.

Finally, the measurement result is checked, the trusted device/application is checked, and the safe boot is completed.

In summary, the TPCM module can measure the startup process and real-time running process of the system. It should be noted that for the single system board, the BIOS needs to actively measure the relevant information of the system or hardware device information. After entering the system, the operation of the entire system can be monitored in real time through the background process. For the server's out-of-band management firmware, such as BMC (Baseboard Management Controller), the command set and driver in the management firmware can also be sent to TPCM for measurement.

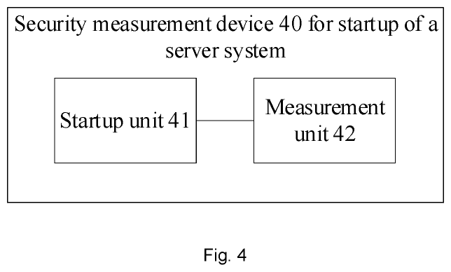

Referring to FIG. 4, this embodiment provides a security measurement device 40 for startup of a server system, the device 40 is applied to the trusted platform control module shown in FIG. 1. Because the technical principle of this embodiment is similar to that of the foregoing method embodiment, the same technical details will not be repeated. The device 40 of this embodiment includes the following parts: a startup unit 41, configured to start the trusted platform control module after the server system is powered on; and a measurement unit 42, configured to measure subsequent startup operations of the server system by the started trusted platform control module to identify and record safety of the startup operations.

In an embodiment, the trusted platform control module includes a preset encryption algorithm and a preset trusted base; the measuring of the startup operation by the trusted platform control module includes: obtaining relevant information of the startup operations; performing encryption calculation on the related information by using the preset encryption algorithm, and comparing a calculation result with the preset trusted base; if a comparison result is consistent, determining the startup operation is safe; if the comparison result is inconsistent, determining the startup operation is unsafe.

In an embodiment, the measuring of the subsequent startup operations of the server system by the started trusted platform control module is performed step-by-step and includes: measuring a system firmware through firmware information read by an SPI master signal before starting the system firmware; sequentially measuring a hardware and an operating system boot file of the server system through hardware information collected by an BIOS (Basic Input Output System) after the BIOS runs; and measuring the operating system and an application program of the operating system through a background process after the operating system runs.

In an embodiment, the measurement unit is further configured to: determine measurement results of startup operations, terminate the subsequent startup operations if a measurement result of one of the startup operations is unsafe.

Those skilled in the art should understand that the division of each module in the embodiment of FIG. 4 is only a division of logical functions, and may be fully or partially integrated into one or more physical entities in actual implementation. And these modules may all be implemented in the form of processing component calling by software, or they may all be implemented in the form of hardware. It is also possible that some modules are implemented in the form of processing component calling by software, and some modules are implemented in the form of hardware.

The present disclosure further provides a server, which includes a trusted platform control module, as shown in FIG. 1. The trusted platform control module includes the above security measurement device 40 for startup of a server system.

In summary, the security measurement method and security measurement device for startup of a server system, and the server of the present disclosure adopt the state-owned standard TPCM with domestic independent intellectual property rights for trusted protection, which is compatible with the SPI and other general interfaces of the trusted nodes of traditional servers. When the server system is powered on and starts, the TPCM trusted root will be used as the trusted source to start first. The firmware (including BIOS and BMC) on the server system is measured first, and then the firmware BIOS on the server motherboard is run. The Boot Block of BIOS measures other hardware on the server system, such as CPU, memory, PCIe devices (network card, memory card, NVMe SSD, etc.), and measures the OS boot loader (Operating System boot file) at the end of startup of BIOS. After entering the operating system, the operating system itself and the applications running in the system are measured. Through such a step-by-step measurement process, a complete trusted chain is established. The present disclosure effectively overcomes various shortcomings and has high industrial utilization value.

The above-mentioned embodiments are just used for exemplarily describing the principle and effects of the present disclosure instead of limiting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

We claim:

1. A security measurement method for startup of a server system, wherein the method is applied to a trusted platform control module of the server system, and the method comprises:
starting the trusted platform control module after the server system is powered on; and
measuring subsequent startup operations of the server system by the started trusted platform control module to identify and record safety of the startup operations.

2. The security measurement method according to claim 1, wherein the trusted platform control module comprises a preset encryption algorithm and a preset trusted base; the measuring of the startup operations by the trusted platform control module includes:
obtaining relevant information of the startup operations;
performing encryption calculation on the related information by using the preset encryption algorithm, and comparing a calculation result with the preset trusted base;
if a comparison result is consistent, determining the startup operation is safe; if the comparison result is inconsistent, determining the startup operation is unsafe.

3. The security measurement method according to claim 1, wherein the measuring of the subsequent startup operations of the server system by the started trusted platform control module is performed step-by-step and includes:
measuring a system firmware through firmware information read by an SPI (Serial Peripheral Interface) master signal before starting the system firmware;
sequentially measuring a hardware and an operating system boot file of the server system through hardware information collected by an BIOS (Basic Input Output System) after the BIOS runs; and
measuring the operating system and an application program of the operating system through a background process after the operating system runs.

4. The security measurement method according to claim 3, further comprising:
determining measurement results of startup operations, terminating the subsequent startup operations if a measurement result of one of the startup operations is unsafe.

5. A security measurement device for startup of a server system, wherein the device is applied to a trusted platform control module of the server system, and the device comprises:
a startup unit, configured to start the trusted platform control module after the server system is powered on; and
a measurement unit, configured to measure subsequent startup operations of the server system by the started trusted platform control module to identify and record safety of the startup operations.

6. The security measurement device according to claim 5, wherein the trusted platform control module comprises a preset encryption algorithm and a preset trusted base; the measuring of the startup operations by the trusted platform control module includes:
obtaining relevant information of the startup operations;
performing encryption calculation on the related information by using the preset encryption algorithm, and comparing a calculation result with the preset trusted base;
if a comparison result is consistent, determining the startup operation is safe; if the comparison result is inconsistent, determining the startup operation is unsafe.

7. The security measurement device according to claim 5, wherein the measuring of the subsequent startup operations of the server system by the started trusted platform control module is performed step-by-step and includes:
measuring a system firmware through firmware information read by an SPI (Serial Peripheral Interface) master signal before starting the system firmware;
sequentially measuring a hardware and an operating system boot file of the server system through hardware information collected by an BIOS (Basic Input Output System) after the BIOS runs; and
measuring the operating system and an application program of the operating system through a background process after the operating system runs.

8. The security measurement device according to claim 7, wherein the measurement unit is further configured to: determine measurement results of startup operations, terminate the subsequent startup operations if a measurement result of one of the startup operations is unsafe.

9. A server, comprising: a trusted platform control module; wherein
the trusted platform control module includes a security measurement device for startup of a server system, wherein the device comprises:
a startup unit, configured to start the trusted platform control module after the server system is powered on; and
a measurement unit, configured to measure subsequent startup operations of the server system by the started trusted platform control module to identify and record safety of the startup operations.
